(19) United States
(12) Patent Application Publication
(10) Pub. No.: US 2005/0047073 A1
(43) Pub. Date: Mar. 3, 2005

(54) Notebook computer having night illumination

(76) Inventor: Li-Chun Lo, Hsin Chuang City (TW)

Correspondence Address: RABIN & BERDO, P.C., Suite 500, 1101 14 Street, N.W., Washington, DC, 20005, US

(21) Appl. No.: 10/754,606

(22) Filed: Jan. 12, 2004

(30) Foreign Application Priority Data
Aug. 28, 2003 (TW) 92215588

(51) Int. Cl. G06F 1/16

(52) U.S. Cl. 361/683; 362/253

(57) ABSTRACT

A notebook computer having night illumination device is disclosed. The present invention comprises: a main body; a keyboard embedded in the main body; a display panel, wherein one side of the display panel is connected to one side of the main body; and at least one light source disposed in the display panel, wherein the light source is used to emit light to illuminate the keyboard. Moreover, the aforementioned display panel therein can comprise a liquid crystal display (LCD). Furthermore, the aforementioned light source can be such as light emitting diode (LED), etc.

### FIELD OF INVENTION

The present invention relates to a notebook computer, more particularly to a notebook computer having a night illumination device.

### BACKGROUND OF THE INVENTION

By highly development of information technology (IT), applications for electrical and informational products become more popular, and computer systems and related peripheral industries have more progress with giant strides. The computer operates centrally with a motherboard, and during operational process, besides a central processing unit (CPU) for calculating operations, and includes other peripheral devices, such as a floppy disk (FD) drive, a hard disk (HDD), a compact disk read-only memory (CD-ROM) drive, a rewritable CD (CD-RW) drive, a digital video disk (DVD) drive and so on.

The notebook computer product has been matured more and more, the price thereof is more reasonable, and the production yield thereof is also increasing. Further, upon the influence of cheaper key components, the occupation rate of the notebook computer is approaching to that of the desktop computer. Besides, the functions and performance of the notebook computer have been approaching to those of the desktop computer. Therefore, the occupation rate of the notebook computer should increase substantially due to requirements for office mobility and the electronic-enterprise trend caused by the popular use of the Internet in the world.

Nowadays, the liquid crystal display (LCD) of the notebook computer for showing output image, has enough output brightness to allow output image clearly recognized by the user at night. There is no light source or dim light source set on the LCD. However, when the user utilizes the notebook computer at night without any light source or dim light source, the user could not clearly recognize the words on the keyboard merely by using the light source outputted from the LCD of the notebook computer. Therefore, it is caused that the keyboard of the notebook computer is not suitable for using at night and in the condition without light source or with a dim light source. For the forgoing reasons, there is a need for searching a solution.

### SUMMARY OF THE INVENTION

The present invention is directed to a notebook computer having a night illumination device, which is convenient to operate the keyboard by providing illumination required for using the notebook computer at night or with a dim light source.

In accordance with the aforementioned and other objectives of the present invention, the present invention provides a notebook computer having a night illumination device. In a preferred embodiment of the invention, the notebook computer having a night illumination device at least comprises: a main body; a keyboard embedded in the main body; a display panel, wherein one side of the display panel is connected to one side of the main body; and at least one light source disposed in the display panel, wherein the light source is used to project light to illuminate the keyboard. Besides, the aforementioned display panel may at least comprise a LCD. Moreover, the aforementioned light source is such as a light emitting diode (LED). In addition, in the invention, the words on the keyboard are further printed by adopting fluorescent dyes, and cooperated with an ultraviolet light-LED light source, also to achieve the purpose that is convenient to operate the keyboard at night or during a dim light source.

Accordingly, it is applied with the invention, which provides illumination required for a notebook computer at night or during a dim light source, so as to be convenient to operate the keyboard.

It is to be understood that both the aforementioned general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is depicted in a three-dimensional diagram of a notebook computer having a night illumination device according to one preferred embodiment of the invention; and

FIG. 2 is depicted in a partially lateral diagram of a notebook computer with a night illumination device according to one preferred embodiment of the invention, wherein a partially cross-sectional diagram is included.

### DETAILED DESCRIPTION OF THE PREFERRED EMBODIMENT

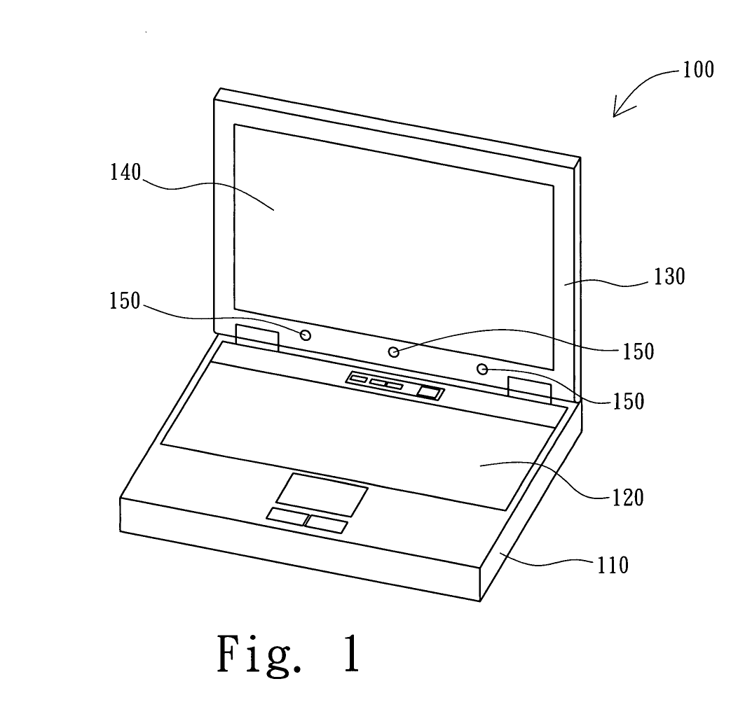

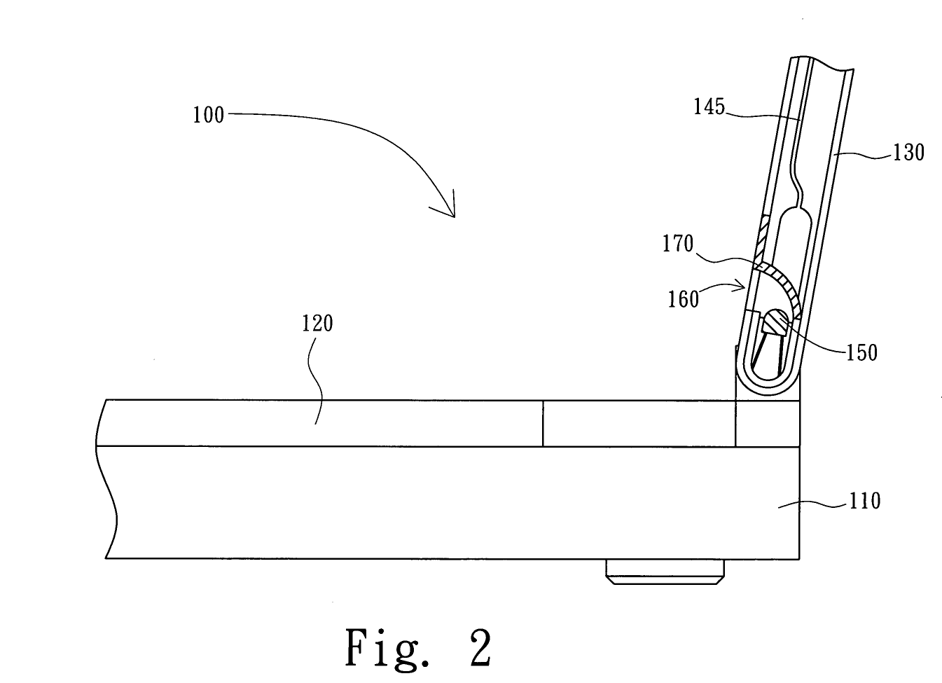

The invention discloses a notebook computer having a night illumination device, which provides illumination required for a notebook computer at night during a dim light source, so as to be convenient to operate the keyboard. Reference will now be made in detail to the present preferred embodiments of the invention, examples of which are illustrated in the accompanying drawings of FIGS. 1 to 2. Wherever possible, the same reference numbers are used in the drawings and the description to refer to the same or like parts.

Please refer to FIG. 1, which is depicted in a three-dimensional diagram of a notebook computer having a night illumination device according to one preferred embodiment of the invention. As mentioned as FIG. 1, the notebook computer 100 comprises components of a main body 110, a keyboard 120, a display panel 130 and so on, wherein the keyboard 120 is embedded in a top surface of the main body 110. One side of the display panel 130 is pivoted to the main body 110, by rotating the display panel 130 around a pivot axis, so that it makes the display panel 130 open as the state shown in FIG. 1, or makes the notebook computer closed (not shown) by covering the display panel onto the top surface of the main body 110. In addition, the display panel 130 is at least consisted of a LCD 140 and so on, for showing output image of the notebook computer 100. Moreover, as a person skilled in the components of the notebook computer 100, the main body 110 further comprises components such as a motherboard, a central processing unit (CPU), a memory, a floppy disk (FD) drive, a hard disk (HDD), a compact disk read-only memory (CD-ROM) drive, a rewritable CD (CD-RW) drive, a digital video disk (DVD) drive and so on (but all not shown in FIG. 1).

The invention is characterized by at least one light source disposed in the notebook computer, so as to be convenient to operate the keyboard by providing illumination required for using the notebook computer at night or with a dim light. As shown in FIG. 1, each light source 150 is disposed in the pore surrounding to the display panel 130, preferably disposed in the pore adjacent to the keyboard, for example, three sets of light sources depicted in FIG. 1. Due to each light source 150 disposed in the pore of the display panel 130, light generated by each light source 150 is projected outward onto the surface of the main body 110 of the notebook computer 100, consequently to illuminate the keyboard 120 and so on, and to be convenient to use the notebook computer 100 at night or with a dim light source. With regard to the kinds of the light sources 150, there are such as a light emitting diode (LED) and so on.

Please refer to FIG. 2, which is depicted in a partially lateral diagram of a notebook computer with a night illumination device according to one preferred embodiment of the invention, wherein a partially cross-sectional diagram is included. In the partially cross-sectional diagram of FIG. 2, in addition to the aforementioned components depicted in FIG. 1, it is further depicted in a LCD component 145, a reflection device 170 and so on, wherein the LCD component 145 is embedded in the display panel 130 for showing output image of the notebook computer 100.

Besides, as mentioned as above, the invention is characterized by at least one light source 150 disposed in the notebook computer 100, and the light sources 150 disposed in the pores 160 of the display panel 130 adjacent to the keyboard 120. Due to the light sources 150 are disposed in the pores 160 of the display panel 130, light generated by the light sources 150 is reflected by a reflection device 170, and then projected outward to the notebook computer 100, consequently illuminating the keyboard 120, so as to be convenient to the user for using the notebook computer 100 at night or with a dim light to key in data or to operate the computer. In addition, the shape and the material of the reflection device 170 are not limited, which can reflect light projected from the light source 150 back onto the keyboard 120, such as a concave mirror.

Moreover, keyboard words on the keyboard 120 surface of the invention may also be printed by adopting fluorescent dyes, and further cooperated with the light sources 150 made by the ultraviolet light-LED, or cooperated with the light sources 150 which at least can emit ultraviolet light, or cooperated with the light source 150 which can make any fluorescent dye of the keyboard words glistening, hence to make the notebook computer applied at night and in the condition without light source or with a dim light source, so as to be convenient to operate the keyboard.

For this reason to sum up, it is understood that the invention is applied to provide illumination required for a notebook computer at night or with a dim light source, so as to be convenient to operate the keyboard according to one preferred embodiment of the invention.

Although the present invention has been disclosed in considerable detail with a certain preferred embodiments thereof, other embodiments are possible. Therefore, their spirit and scope of the appended claims should no be limited to the description of the preferred embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A notebook computer having a night illumination device, comprising:
a main body;
a keyboard disposed on a surface of the main body;
a display panel, wherein a side of the display panel is connected to a side of the main body in a rotatable way;
at least a light source which is disposed in the display panel and electrically connected to the display panel, for emitting light to illuminate the keyboard; and
a reflection device disposed in the display panel and at a backside of the light source, for reflecting the light emitted from the light source onto the keyboard.

2. The notebook computer having a night illumination device of claim 1, wherein the display panel at least comprises a liquid crystal display (LCD).

3. The notebook computer having a night illumination device of claim 1, wherein the light source is a light emitting diode (LED).

4. The notebook computer having a night illumination device of claim 1, wherein there are a plurality of words printed on the keyboard by adopting fluorescent dyes.

5. The notebook computer having a night illumination device of claim 4, wherein the light source is an a ultraviolet light-LED.

6. The notebook computer having a night illumination device of claim 4, wherein a light projected from the light source at least includes ultraviolet light.

7. The notebook computer having a night illumination device of claim 1, wherein the keyboard is disposed at the front side of the light source.

8. The notebook computer having a night illumination device of claim 1, wherein the reflection device is a concave mirror.

9. A notebook computer having a night illumination device, comprising:
a main body;
a keyboard disposed on a surface of the main body;
a liquid crystal display panel, wherein a side of the liquid crystal display panel is pivoted to a side of the main body in a rotatable way;
at least a light emitting diode which is disposed in the liquid crystal display panel and electrically connected to the liquid crystal display panel, for emitting light to illuminate the keyboard; and
a concave mirror disposed in the liquid crystal display panel and at a backside of the light emitting diode, for reflecting the light emitted from the light emitting diode onto the keyboard.

10. The notebook computer having a night illumination device of claim 9, wherein there are a plurality of words printed on the keyboard by adopting fluorescent dyes.

11. The notebook computer having a night illumination device of claim 10, wherein the light emitting diode is an ultraviolet light-LED.

12. The notebook computer having a night illumination device of claim 10, wherein a light projected from the light emitting diode at least includes ultraviolet light.

13. The notebook computer having a night illumination device of claim 9, wherein the keyboard is disposed at the front side of the light source.

14 (Cancelled).
